(19) United States
(12) Patent Application Publication
(10) Pub. No.: US 2013/0061289 A1
(43) Pub. Date: Mar. 7, 2013

(54) Secure Messaging

(71) Applicants: Keith McFarland, Annapolis, MD (US); Doug Kesser, Mooresville, NC (US); Joseph Pohutsky, Annapolis, MD (US)

(72) Inventors: Keith McFarland, Annapolis, MD (US); Doug Kesser, Mooresville, NC (US); Joseph Pohutsky, Annapolis, MD (US)

(21) Appl. No.: 13/409,695

(22) Filed: Mar. 1, 2012

Related U.S. Application Data
(60) Provisional application No. 61/457,324, filed on Mar. 1, 2011.

(51) Int. Cl. G06F 21/00

(52) U.S. Cl. 726/4

(57) ABSTRACT

A secure messaging interface enables submission of messages to a messaging gateway via secure means over TLS. A destination mobile device(s) is notified of a pending secure message, and holds the secure message until it is retrieved by an authorized mobile device. The messaging gateway also provides push services for sending data to wireless devices. The secure messager enables sending devices to apply security to an individual message. Sending devices may include, e.g., an enterprise administration server; messages routed through an messaging gateway (MGW) portal; an user messaging application; or a user through a handset. The secured messages may include content as available today across any messaging protocol such as text, audio, video, binaries and images.

### BACKGROUND OF THE INVENTION

1. Field of the Invention

This invention relates generally to telecommunications. More particularly, it relates to wireless telecommunications text and multi-media messaging & location messaging.

2. Background of Related Art

Consumers and businesses have long sought a secure method to deliver messages to mobile devices. Existing off-the shelf technologies for secure methods of delivering messages are in fact not totally secure, and/or are too complex, requiring overly complicated and proprietary components. Existing technologies tend to automatically push so-called secure messages to devices without authorization, allowing a level of insecurity in those conventional systems.

### SUMMARY OF THE INVENTION

In accordance with the principles of the present invention, a method of providing a secure message securely to a mobile device comprises receiving a reference ID relating to a secure message, but not including the secure message, at a messaging gateway (MGW) server. The reference ID is routed from the messaging gateway server toward a destination mobile device via various available standard methodologies. An authorized request to send the secure message is accepted from the destination mobile device, the authorized request including the reference ID and a code authorizing receipt of the secure message. The secure message is routed from the messaging access gateway server to the destination mobile device.

In accordance with another embodiment of the present invention, a method of passing a secure message securely between mobile devices comprises receiving a reference ID relating to a secure message sent by a sending mobile device, but not including the secure message, at a messaging gateway (MGW) server. The reference ID is routed from the messaging gateway server to a message distribution center. The reference ID is routed from the message distribution center toward a destination mobile device. An authorized request to send the secure message is accepted, from the destination mobile device, the authorized request including the reference ID and a code authorizing receipt of the secure message. The secure message is routed from the messaging gateway server to the destination mobile device.

### BRIEF DESCRIPTION OF THE DRAWINGS

Features and advantages of the present invention become apparent to those skilled in the art from the following description with reference to the drawings, in which:

FIG. 1 shows secure messaging graphical user interface (GUI) mobile terminated flow, e.g., GUI to handset, in accordance with the principles of the present invention.

FIG. 2 shows a messaging gateway (MGW) (GUI) portal user experience for secure messaging, in accordance with the principles of the present invention.

FIG. 3 shows exemplary user application mobile terminated flow, e.g., XML to handset, in accordance with the principles of the present invention.

FIG. 4 shows exemplary secure messaging application mobile originated flow, e.g., handset to messaging protocol, in accordance with the principles of the present invention.

FIG. 5 shows exemplary secure messaging application mobile originated flow, e.g., handset to MGW GUI, in accordance with the principles of the present invention.

FIG. 6 shows exemplary secure messaging application mobile-to-mobile flow, in accordance with the principles of the present invention.

FIG. 7 shows exemplary secure messaging with no secure messaging application, in accordance with the principles of the present invention.

### DETAILED DESCRIPTION OF ILLUSTRATIVE EMBODIMENTS

The present invention allows consumer devices to send/receive messages securely. The secure messages sent securely according to the principles of the present invention may contain text, images, video, binaries and/or audio encodings. The secure messages may be secured from various sources, e.g., (but not limited to): web portals, SMTP, SMPP, SNPP, WCTP and XML to any mobile device supporting means to use mobile device specialized application technology over TLS.

The present invention provides a secure messaging system and method for mobile devices to receive and transmit secure messages securely to both mobile and non-mobile devices.

Functionally, the disclosed embodiments have three main components: a secure messaging interface for non-mobile devices; a secure messaging engine; and a secure messaging interface for mobile devices.

The secure messaging interface for non-mobile devices enables submission of messages to a messaging access gateway via secure means over HTTPS.

The secure messaging engine & repository provides a unique solution for secure messaging. The secure messaging engine notifies mobile devices of pending secure messages and holds secure messages until they are retrieved by a mobile device over one of two means. Additionally, the secure messaging engine performs mobile device and user authentication to ensure that only authorized devices and operators are able to retrieve a secure message.

The secure messaging interface for mobile devices, e.g., an HTTPs mobile web portal interface, is an interface for mobile devices to retrieve authorized secure messages, and to submit new secure messages if they do not or cannot use the secure messaging application. The secure messaging interface for mobile devices which support a mobile secure messaging application utilize the application interface.

Secure messaging in accordance with the principles of the present invention provides users with a secure means of delivering a message from end-to-end. It gives the sending device the option to encrypt a message prior to sending, including between portal and handset; between originating application and handset; and between handsets. The messaging gateway also provides push services for sending data to wireless devices

The secure messager in accordance with the principles of the present invention enables sending devices to apply security to an individual message. Sending devices may include, e.g., a user's administration server; messages routed through a messaging gateway (MGW) portal; a user application; or a user through a mobile device.

The secured messages are held in an encrypted manner on the messaging gateway (MGW) until retrieved by the destination parties. The messaging gateway (MGW) will deliver notifications to all destination parties via multiple external means available to the mobile device. The notification will contain at least a secure message reference ID, an alphanumeric code and an optional web URL. At a minimum, these two parameters (message reference id and code) will uniquely identify the secure message within the messaging gateway (MGW). Additionally, the messaging gateway (MGW) may require additional verification techniques such as user authentication and mobile device authentication upon retrieval of the messages by the destination parties. These additional security requirements can be configured by the invention on a per destination basis.

Preferably, all messaging protocols are supported for secure messaging (e.g. but not limited to SMTP, SNPP, XML, WCTP). Existing security means may be applied between the user application or administration server and the delivery of messages to the MGW. The secure messaging invention is compatible with all existing mobile devices that support the mobile messaging client application with secure messaging components. Alternatively, mobile devices with basic web browser HTTPS capability are compatible with the invention. Messages sent and received by an MGW are preferably stored in a securely encrypted data store.

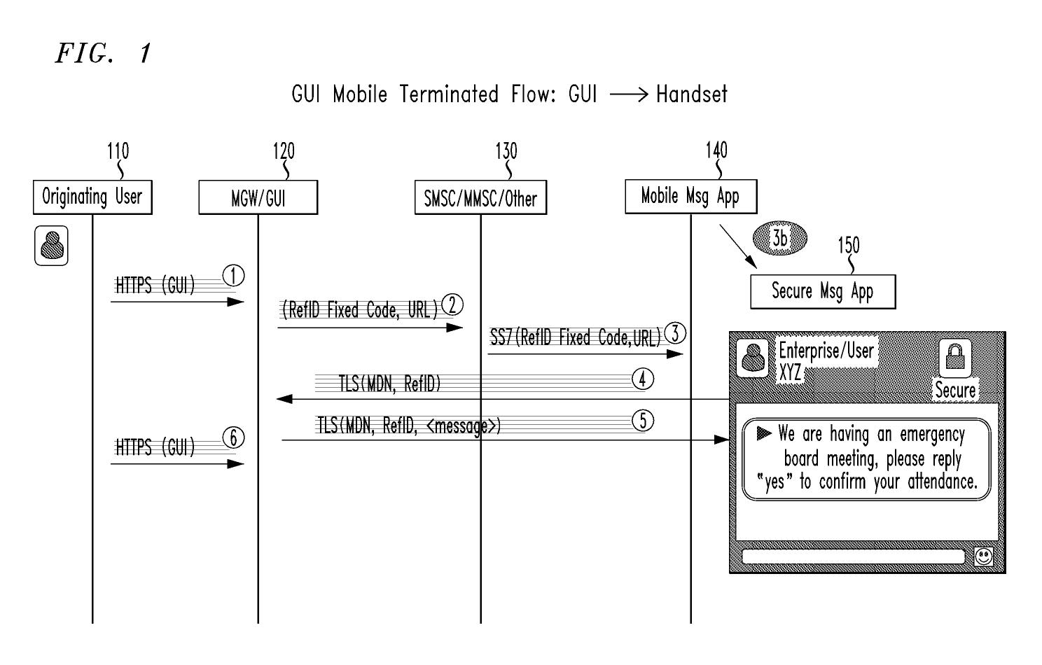

FIG. 1 shows secure messaging graphical user interface (GUI) mobile terminated flow, e.g., GUI to handset, in accordance with the principles of the present invention.

In particular, as shown in step 1 of FIG. 1, the originating user 110 logs into an MGW portal 120 and creates a message (optionally with multi-media) and elects to send it securely.

In step 2, the MGW 120 sends a reference ID and alphanumeric code to a message distributing server, e.g., to a short message service center (SMSC) 130 using, e.g., SMPP.

In step 3, the message distribution server 130 forwards the reference ID and fixed code on to the mobile device running a compatible message application 140 using, e.g., SS7 or other suitable communication protocol.

In step 3b, the same mobile device running a secure message client application 150 reads/receives the RefID and code from the mobile message application 140. In step 4, the secure message client application 150 makes a TLS call to the MGW 120 to retrieve the secured message.

In step 5, the MGW 120 authenticates the request to retrieve the secured message 150, and responds by securely delivering the secured message to the mobile device 150. The authentication used by the MGW, not pictured, may vary based upon external requirements.

In step 6, the originating user 110 then has the option of logging into the MGW portal 120 to see results.

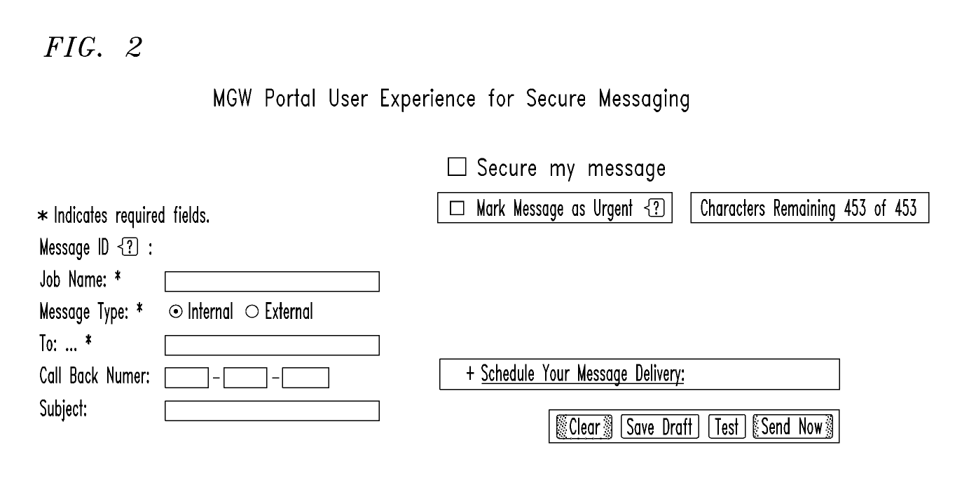

FIG. 2 shows an messaging gateway (MGW) portal user experience for secure messaging, in accordance with the principles of the present invention.

In particular, FIG. 2 depicts an exemplary messaging portal of an messaging gateway. The messaging portal includes typical fields, e.g., name, message type (internal or external to enterprise), TO address, callback number, and subject. The exemplary messaging portal also prompts for marking of a given message as “Urgent”, permits delivery of the message to be scheduled at some time in the future, and indicates a number of characters remaining (e.g., 453 of 453).

Most importantly and pertinently to the present invention, the messaging portal provides a prompt for the drafting device to prompt for an indication to “Secure my message”.

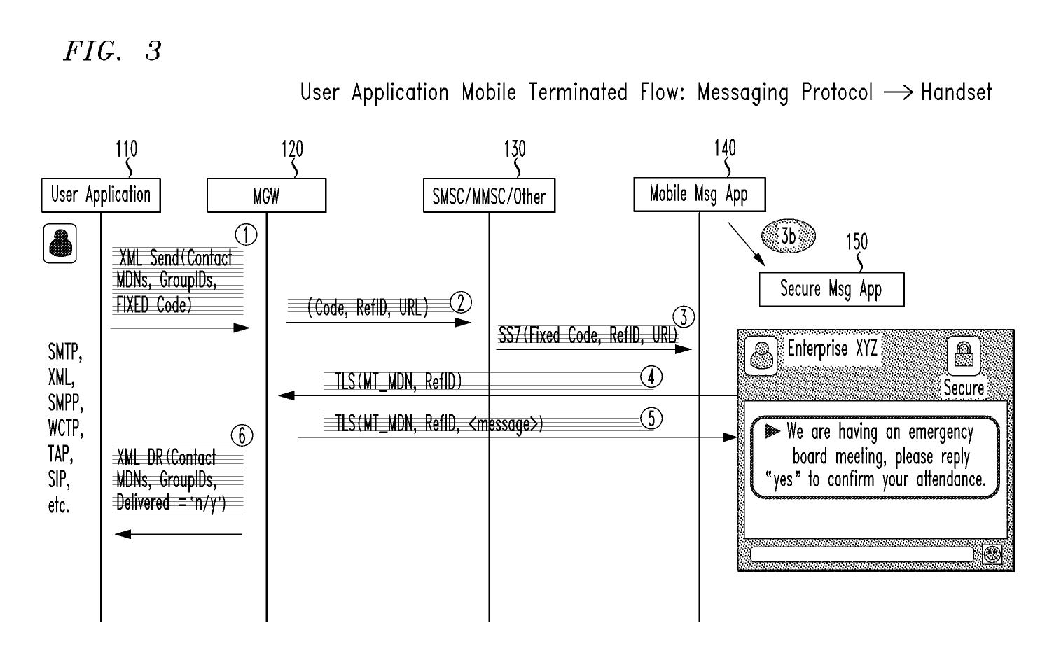

FIG. 3 shows exemplary user application mobile terminated flow, e.g., XML to handset, in accordance with the principles of the present invention.

In particular, as shown in step 1 of FIG. 3, the messaging enterprise device 110 sends an messaging request e.g. XML over a secure transport to the messaging gateway (MGW) 120 to send a message securely with a fixed code (identifying the secure connection) and optionally with multi-media attached.

In step 2, the messaging gateway (MGW) 120 creates a reference ID and sends it along with the fixed code, as a message, on to the message distribution server, e.g., to a short message service center (SMSC) 130.

In step 3, the message distribution server 130 forwards the reference ID and fixed code to the destination mobile device with the compatible mobile messaging application 140.

In step 3b, the same mobile device running a secure message client application 150 reads/receives the RefID and code from the mobile message application 140.

In step 4, the secure message client application 150 makes a secure TLS call to the MGW 120 to retrieve the secured message.

In step 5, the messaging gateway (MGW) 120 authenticates the request from the mobile device 150 and responds with the authenticated, secure message. The authentication used by the MGW, not pictured, may vary based upon external requirements.

In step 6, optionally, the messaging gateway (MGW) 120 responds back to the sending user application 110 with delivery results.

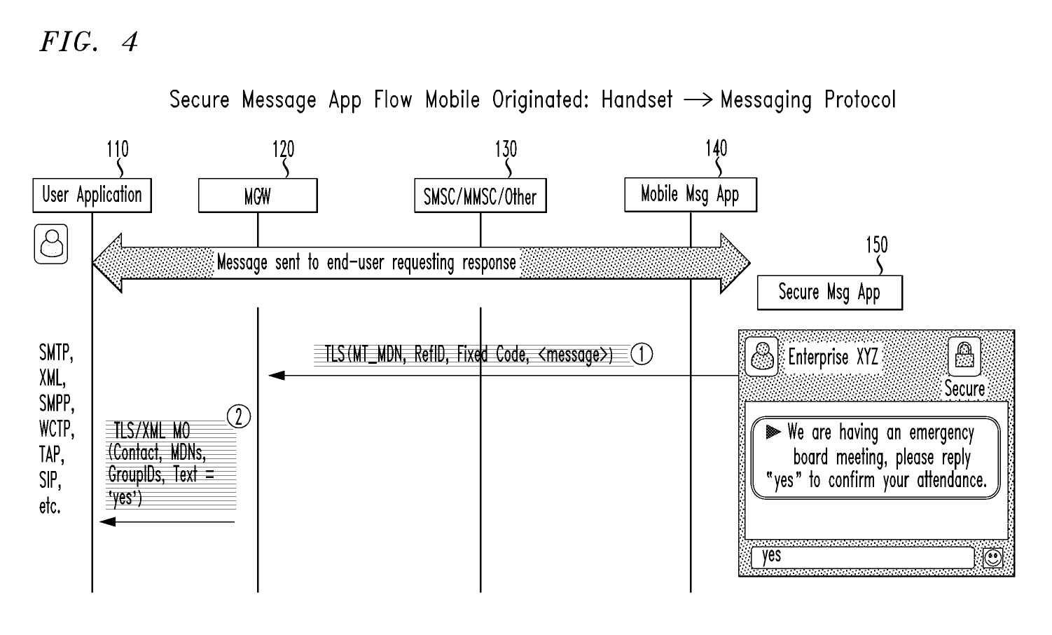

FIG. 4 shows exemplary secure messaging application mobile origination flow, e.g., handset to messaging protocol e.g. XML, in accordance with the principles of the present invention.

Preceding step 1, the mobile device operating the secure messaging application 150, may have already received a previously secure message. In particular, as shown in step 1 of FIG. 4, an end user device operating the secure messaging application 150 ‘confirms’ the text of a fresh, secure message, and selects ‘send’. The end user device running the secure message client application 150 passes the message securely over TLS to the messaging gateway (MGW) 120 with a reference ID (RefID) and fixed code.

In step 2, the messaging gateway (MGW) 120 securely sends the message via a messaging protocol (e.g. XML over TLS) to the corresponding user device or application 110. The code and reference id may be used by the messaging gateway (MGW) 120 to determine the specific method (e.g. XML) and destination for delivery to the user device/application 110. The pathway between the messaging gateway 120 and the user device application 110 may apply existing security measures (e.g. TLS) which may vary based upon external factors and messaging protocols.

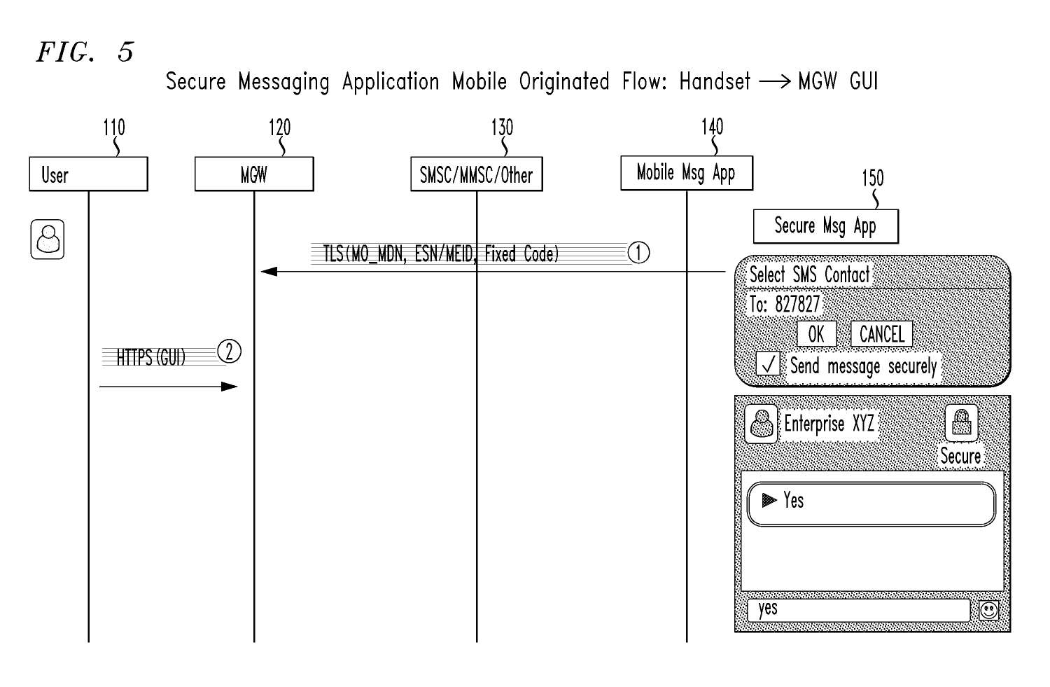

FIG. 5 shows exemplary secure messaging application mobile originated flow, e.g., handset to MGW GUI, in accordance with the principles of the present invention.

In particular, as shown in step 1 of FIG. 5, the end user mobile device operating the secure messaging application 150 sends a secure message with a fixed code to the messaging gateway (MGW) 120. The secure message does not require a reference ID here as it is the originator of the secure message. It does require a specific code which may be a fixed code to identify the GUI as the destination and will use TLS as the transport when security is selected, e.g., when a ‘Send message securely” check box as shown in FIG. 5 is populated.

In step 2, the user 110 then has the option to log into the MGW GUI portal to see the message.

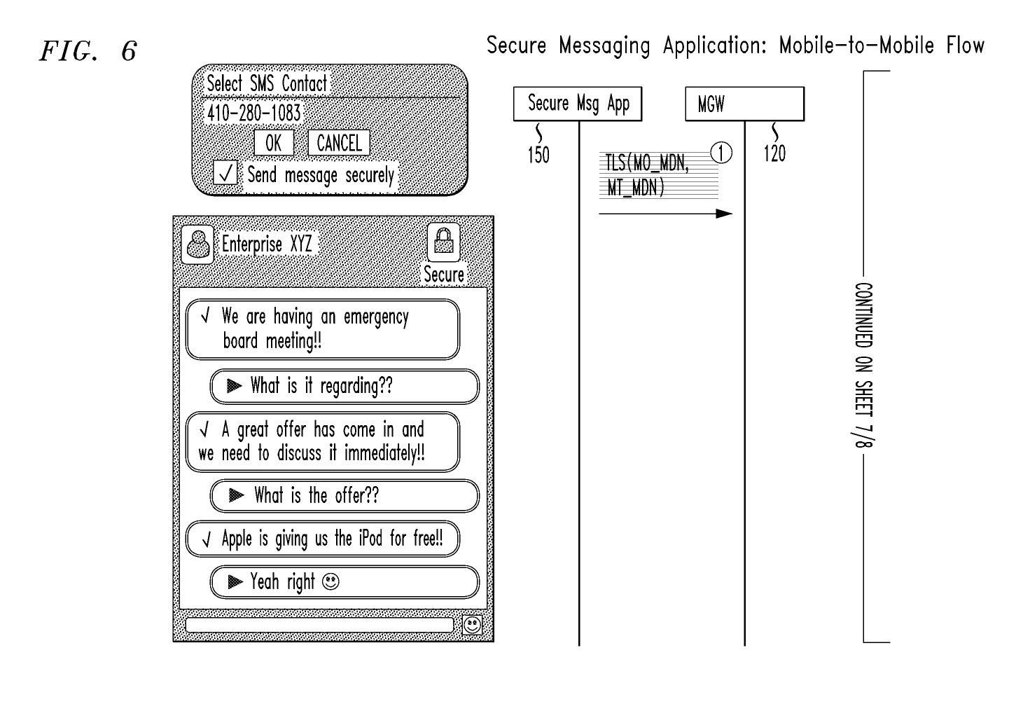

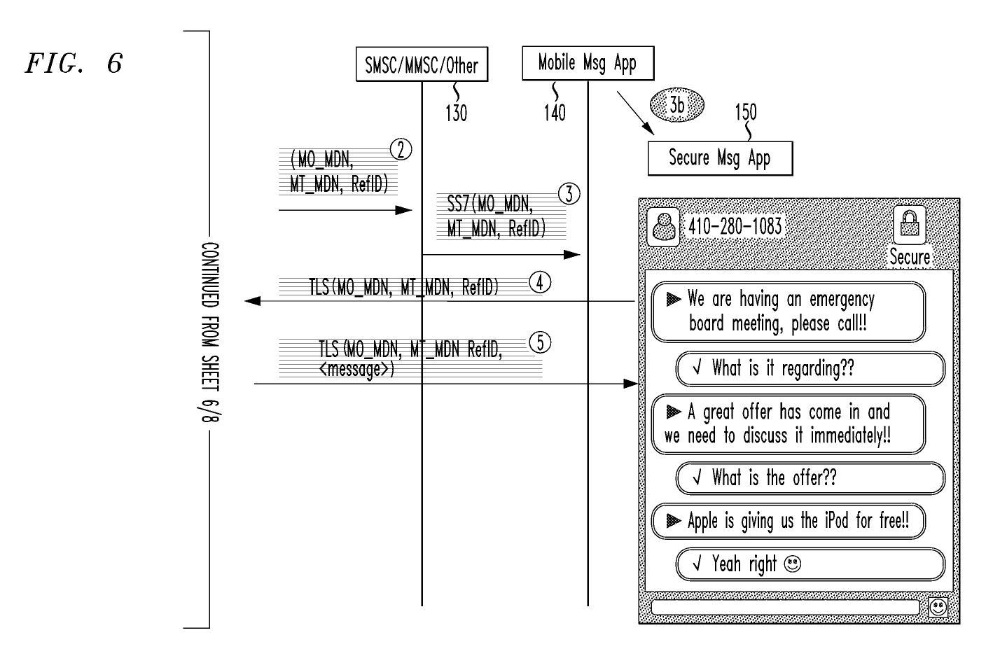

FIG. 6 shows exemplary secure messaging application mobile-to-mobile flow, in accordance with the principles of the present invention.

In particular, as shown in step 1 of FIG. 6, the end-user mobile device with a secure messaging application 150 selects to send a secure message securely, composes the secure message, and then sends the secure message securely to the messaging gateway (MGW) 120 via TLS.

In step 2, the messaging gateway (MGW) 120 sends a reference ID, MO_MDN, and MT_MDN to the message distribution server (e.g. SMSC) 130.

In step 3, the message distribution server 130 forwards the reference ID, MO_MDN, and MT_MDN on to the destination(s) mobile device running a compatible mobile messaging application 140.

In step 3b, the same mobile device running a secure message client application 150 reads/receives the RefID and code from the mobile message application 140.

In step 4, the secure message client application 150 makes a secure TLS call to the MGW 120 to retrieve the secured message.

In step 5, the messaging gateway (MGW) 120 authenticates the request, and responds by securely delivering the secure message to the mobile device 140. The authentication used by the MGW, not pictured, may vary based upon external requirements.

Thus, a secure messaging portal provides a means for end-user mobile devices that do not have a secure messaging portal to authorize and securely retrieve and send secure messages. The secure messaging portal preferably supports inter-carrier messaging. Moreover, secure messaging in accordance with the present invention may also be enjoyed with devices not compatible with the secure messaging application.

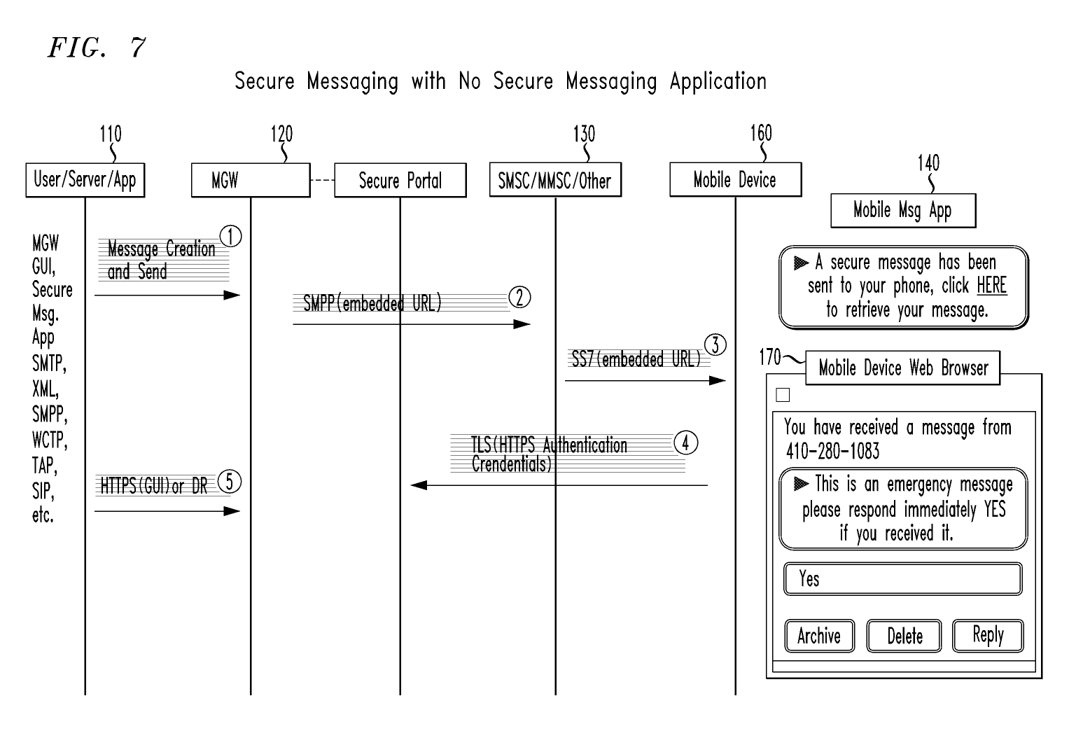

FIG. 7 shows exemplary secure messaging with no secure messaging application, in accordance with the principles of the present invention.

In particular, as shown in step 1 of FIG. 7, the device 110 submits a message to the messaging gateway (MGW) 120, or creates a message via the messaging gateway GUI (see FIGS. 1-3).

In step 2, the messaging gateway (MGW) 120 makes a determination that the end (destination) mobile device 140 is inter-carrier, or does not support an application for secure messaging. The messaging gateway (MGW) 120 sends a message (e.g., an SMS message) with an embedded URL, to a suitable message distribution server 130, e.g., SMSC.

In step 3, the end-user mobile device 160 receives the message with embedded unique universal resource locator (URL) through its mobile messaging application 140. Upon selection of the unique URL, a browser in the mobile device 170 is directed to a secure messaging portal authentication page.

In step 4, upon successful login, the authorized end user mobile device 140 can then view the secure message. Actions they can be accomplished by the mobile device 140 include Reply to secure message, Delete secure message, and Archive secure message.

In step 5, lastly, the originating user/device/application 110 has the option of logging in to the messaging gateway (MGW) 120 and retrieving a result of the secure message or receiving a delivery receipt either options is defined as per FIGS. 1-3.

Reference ID (RefID) is the public key used by a destination device to retrieve a secure message from the messaging gateway (MGW). The destination device uses TLS to pass a public key to the messaging gateway (MGW) 120. The messaging gateway (MGW) 120 uses the public key and a alphanumeric code to identify the secure message, and the mobile device 140.

A method is applied against the public key which may take into account various elements depending on the desired security level of the enterprise.

Secure messages may be identified as ‘secured’ through the use of an appropriate icon and/or textual notices. Secure messages preferably have the same reporting content as unsecure messages.

An administrative portal to the secure messaging distributor within the messaging gateway (MGW) 120 enables administrative functions, e.g., remote wipe, forward lock, and/or password configuration. The secure messaging administrative portal also may enable user configuration/administration through the portal of the messaging gateway (MGW) GUI 120. The secure messaging administrative portal may enable consumer configuration and administration through a consumer facing portal (e.g., via a suitable wireless Internet gateway (WIG).)

The present invention has particular applicability to consumers and businesses in any space that require or prefer the use of secure messaging.

While the invention has been described with reference to the exemplary embodiments thereof, those skilled in the art will be able to make various modifications to the described embodiments of the invention without departing from the true spirit and scope of the invention.

What is claimed is:

1. A method of providing a secure message securely to a mobile device, comprising:
receiving a reference ID and an alphanumeric code relating to a secure message, but not including said secure message, at a messaging gateway (MGW) server;
routing said reference ID, from said messaging access gateway server toward a destination mobile device;
accepting an authorized request to send said secure message, from said destination mobile device, said authorized request including said reference ID and a code authorizing receipt of said secure message; and
routing said secure message from said messaging access gateway server to said destination mobile device.

2. The method of providing a secure message securely to a mobile device according to claim 1, wherein:
said reference ID is routed from said messaging gateway server to said destination mobile device via a message distribution server (e.g. short message service center (SMSC)).

3. The method of providing a secure message securely to a mobile device according to claim 1, further comprising:
accepting a secure message at said messaging gateway server, from a sending device, via TLS using a secure messaging application.

4. The method of providing a secure message securely to a mobile device according to claim 1, further comprising:
accepting a secure message at said messaging gateway server, from a sending device, via any message source protocol (e.g. XML Send).

5. The method of providing a secure message securely to a mobile device according to claim 1, further comprising:
accepting a response from said destination mobile device at said messaging gateway server via TLS.

6. The method of providing a secure message securely to a mobile device according to claim 5, further comprising:
routing said response from said messaging access gateway server toward an initiating device via any messaging source protocol.

7. A method of passing a secure message securely between mobile devices, comprising:
receiving a reference ID relating to a secure message sent by a sending mobile device, but not including said secure message, at a messaging gateway (MGW) server;
routing said reference ID, from said messaging gateway server to a message distribution center;
routing said reference ID from said message distribution server toward a destination mobile device;
accepting an authorized request to send said secure message, from said destination mobile device, said authorized request including said reference ID and a code authorizing receipt of said secure message; and
routing said secure message from said messaging access gateway server to said destination mobile device.

8. The method of passing a secure message securely between mobile devices according to claim 7, wherein:
said message distribution server is a short message service center (SMSC), multimedia message center (MMSC) or Session Initiated Protocol Application Service (SIP AS).

9. The method of passing a secure message securely between mobile devices according to claim 7, further comprising:
accepting a secure message at said messaging gateway server, from said sending mobile device, via TLS.
